(19) United States
(12) Patent Application Publication
(10) Pub. No.: US 2025/0098656 A1
(43) Pub. Date: Mar. 27, 2025

(54) POSITIVE PRESSURE FLY-TYING VISE

(71) Applicant: Tom Ward, Bennett, CO (US)

(72) Inventor: Tom Ward, Bennett, CO (US)

(21) Appl. No.: 18/472,631

(22) Filed: Sep. 22, 2023

(51) Int. Cl. A01K 97/28

(52) U.S. Cl. CPC A01K 97/28

(57) ABSTRACT

A fly-tying vise which utilizes a double lobed cam to apply positive pressure through engagement jaws to hold and stabilize a variety of different sized fly hooks without having to adjust the vise. The fly-tying vise may be removably attachable to a portable plate, the body of a person, or an inanimate object capable of supporting the present invention, creating a portable fly-tying vise which can be used anywhere the user finds necessary.

### FIELD OF THE INVENTION

The present invention pertains to an apparatus for the purpose of tying flies.

### BACKGROUND OF THE INVENTION

The art of tying flies dates back to ancient Macedonia. Over the centuries it has evolved from a rather rudimentary process of binding a hook with natural materials to the complex and anatomically correct fly patterns seen today. The advancements in fly-tying equipment are responsible for creating efficiencies in tying flies as well as the creation of more effective flies. These advancements in technology contributed to the growth of new materials and hook designs used by the modern fly tier.

There exists an identified need for a versatile fly-tying vise that is capable of being utilized with the large variety of hook sizes that are available on the market today. The use of a double lobed cam to apply positive pressure through the engagement jaws to hold and stabilize a variety of fly hooks without adjusting for different hook sizes addresses the previously identified need in the fly-tying vise market. Further, there exists a need for a portable fly-tying vise to address the inherent shortcomings of pre-tying flies before the fly-tier arrives at their fishing location. In order to tie flies which “match the hatch” of a specific geographic area and time of year, the fly-tier must observe not only the characteristics of what bugs are hatching, but also how the target fish species are feeding at that moment in time. These observations are made far from a fly-tiers workbench where they typically tie their flies.

### SUMMARY OF THE INVENTION

The present invention pertains to an apparatus for the purpose of tying flies. Embodiments of the present invention as disclosed provide an apparatus for the purpose of tying flies.

The current market for fly-tying vises utilizes negative pressure and single lobed cams to hold the hook in place. The present invention solves this issue by utilizing a novel combination of a double-lobed cam and positive pressure to hold the hook in place.

Technological advancements in fly-tying vices are not satisfactory with regards to the advancements of modern fly-tying methods. There is an identified need for more effective and user-friendly fly-tying vices that are compatible with a wide range of hook sizes.

It is an aspect of the present invention to provide a fly-tying vise that utilizes a double lobed cam to apply positive pressure through the engagement jaws to hold and stabilize a variety of fly hooks without adjusting for different hook sizes. Embodiments of the present invention as disclosed provide for an apparatus which does not need to be adjusted when using different sized hooks.

It is an aspect of the present invention to provide a fly-tying vise wherein the engagement jaws, the mechanism which physically holds the hook, utilizes positive pressure to stabilize the hook. This differs from traditional vises where users manually close the engagement jaws. The result is a more efficient and user-friendly experience. In addition, a known issue in previous devices is the difficulty of tying flies with different sized hooks. Smaller vices are not capable of exerting enough pressure on larger hooks to hold them steady. Larger vices are cumbersome to use with smaller hooks as they clamp onto a large portion of a small hook which prevents the fly tyer from utilizing a large portion of the small hook.

The present invention comprises a vise that utilizes a double lobed cam to apply positive pressure through the engagement jaws to hold and stabilize a variety of fly hooks without adjustment. In certain embodiments, the engagement jaws may be notched as to accommodate fishhooks of different sizes.

It is an aspect of the present invention to provide for the vise to be removably detachable. In certain embodiments, the detachable vise may include a method of attaching separately to different materials. In certain embodiments, the construction of the fly-tying vice may include magnetic materials. In certain embodiments, the vise may be removably attached to an elongated shaft. In certain embodiments, the vise may be removably attached to a rotary vise via the elongated shaft. In certain embodiments, the vise may be removably attached to a portable plate attachment via the elongated shaft. In certain embodiments, the portable plate attachment may comprise a strap to wear around the body of a person or to interconnect to an inanimate object. In certain embodiments, the rotary vise may consist of a rotary vise handle and rotary rotation cradle. In certain embodiments, the rotary vise may be connected to a vertical support post. In certain embodiments, the vertical support post may be connected to a base or a c-clamp.

In certain embodiments, the base of the fly-tying vise may include depressions in which to store or hold various fly-tying materials or hooks.

Certain embodiments of the present invention comprise a vise body having a proximal end and a distal end and a central longitudinal axis, engagement jaws mounted on the distal end of the body, the engagement jaws being moveable between an open object-receiving position and a closed object-holding position, the engagement jaws remaining parallel to each other as they are moved between their open and closed positions. In certain embodiments, the engagement jaws extend longitudinally along a portion of the central longitudinal axis from the distal end to the proximal end. In certain embodiments, the engagement jaws further comprise a first engagement jaw and a second engagement jaw interconnected to the vise body, and the engagement jaws each have a parallel interior plane therebetween and a parallel exterior plane opposite the parallel interior plane. In certain embodiments, a double lobed cam may be mounted to the vise body along the central longitudinal axis, positioned perpendicular between the first engagement jaw and the second engagement jaw, wherein the actuation of the double lobed cam applies a positive pressure to the parallel interior planes of the engagement jaws moving the engagement jaws from the open object-receiving position to the closed object-holding position. In certain embodiments, one or more of a spring may be located between the parallel exterior planes of each engagement jaw and the vise body, the springs configured to apply an expanding force between the engagement jaws and the vise body in the open object-receiving position.

In certain embodiments, an orifice on the proximal end of the vise body may be capable of receiving a first end of an elongate shaft, wherein the elongate shaft is removably attached to the vise body. Certain embodiments of the present invention may have a second end of the elongate shaft wherein the second end of the elongate shaft is removably attached to a rotary vise connection rod and a rotary vise handle. In certain embodiments of the present invention, the rotary vise connection rod may be partially housed in a rotary rotation cradle, wherein the rotary rotation cradle is supported by a vertical support post. In certain embodiments of the present invention, the vertical support post may be attached to a base. In certain embodiments of the present invention, the base may comprise a clamp for securing the vise to an overhanging edge of a work surface. Certain embodiments of the present invention may have a base capable of self-supporting atop a work surface.

In certain embodiments of the present invention, the vise body may comprise magnetic materials. Certain embodiments of the present invention may have the orifice on the proximal end of the vise body being comprised of magnetic materials. Certain embodiments of the present invention may have the elongate shaft comprising magnetic materials.

Certain embodiments of the present invention may have the double lobed cam interconnected to a handle which actuates rotation of the double lobed cam.

Certain embodiments of the present invention may have the engagement jaws having confronting faces, the confronting faces provided with at least one complementary transverse arcuate groove for receiving, securing, and holding an object. The arcuate groove may be configured such that hooks of different sizes can be clamped between the engagement jaws.

In certain embodiments of the present invention, a second end of the elongate shaft may be removably attached to a portable plate attachment. Certain embodiments of the present invention may have the portable plate attachment comprising one or more of a strap to wear around the body of a person or an inanimate object, capable of supporting the present invention.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should be construed as being representative of the full extent and scope of the present invention. The present invention is set forth in various levels of detail in this Summary, as well as in the attached drawings in the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings and the exemplary claims provided herein.

### BRIEF DESCRIPTION OF THE DRAWING

A complete understanding of the present invention may be obtained by reference to the accompanying drawing, when considered in conjunction with the subsequent detailed description, in which:

FIG. 1 is a front perspective view of certain embodiments of a vise;

FIG. 2 is a front perspective view of certain embodiments of a vise.

FIG. 3 is a front perspective view of certain embodiments of a vise connected to a rotary vise connection and a base.

FIG. 4 is a front perspective view of certain embodiments of a clamp.

FIG. 5 is a front perspective view of certain embodiments of a portable plate attachment.

Like reference numerals refer to like parts throughout the several views of the drawings.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

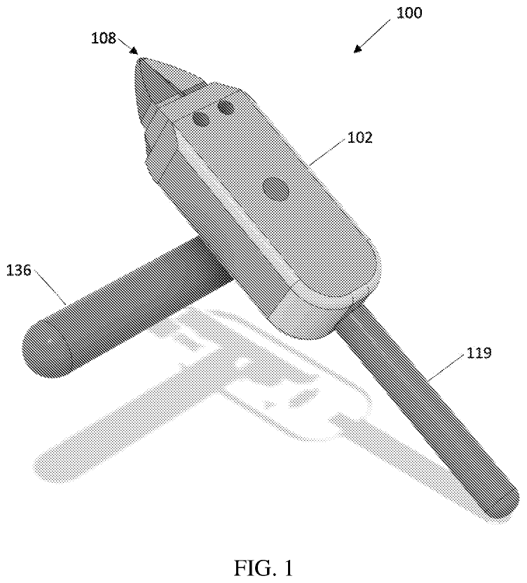

Certain embodiments of a vise 100, seen in FIG. 1, are configured for tying flies. Such embodiments comprise a vise body 102, engagement jaws 108, an elongate shaft 119, and a vise handle 136.

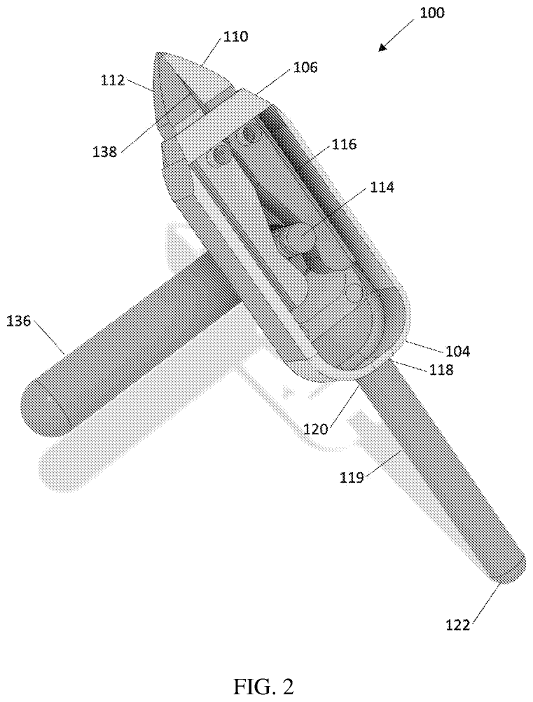

Certain embodiments of a vise 100, as seen in FIG. 2, comprise the vise body proximal end 104 and the vise body distal end 106 with a central longitudinal axis extending between the ends. The engagement jaws 108 are configured such that the engagement jaws 108 are moveable between an open object-receiving position and a closed object-holding position, wherein the engagement jaws remain parallel to each other as they are moved between an open and closed position. The engagement jaws 108 are configured to extend longitudinally along a portion of the central axis from the distal end 106 to the proximal end 104 of the vise body 102. The engagement jaws 108 comprise a first engagement jaw 110 and a second engagement jaw 112 that are interconnected to the vise body 102, wherein each of the engagement jaws 108 comprise a parallel interior plane therebetween and a parallel exterior plane opposite the parallel interior plane. In certain embodiments the engagement jaws 108 have confronting faces, where the confronting faces are provided with at least one complementary transverse arcuate groove 138. A double lobed cam 114 is mounted to the vise body 102 along the central longitudinal axis and is positioned perpendicular between the first engagement jaw 110 and the second engagement jaw 112. The double lobed cam 114 is configured such that the actuation of the double lobed cam 114 applies a positive pressure to the parallel interior planes of the engagement jaws 108, moving the engagement jaws 108 from the open object-receiving position to the closed object-holding position. In certain embodiments, the double lobed cam 114 is interconnected to a vise handle 136 which actuates rotation of the double lobed cam 114. In certain embodiments, one or more of a spring 116 are located between the parallel exterior planes of each engagement jaw 108 and the vise body 102, wherein the springs 116 are configured to apply an expanding force between the engagement jaws 108 and the vise body 102 in the open object-receiving position. In certain embodiments, the vise body proximal end 104 comprises an orifice 118 that is capable of being removably attached to an elongate shaft 119, the elongate shaft 119 having a first end 120 and a second end 122. In certain embodiments, the orifice 118 receives a first end of the elongate shaft 120.

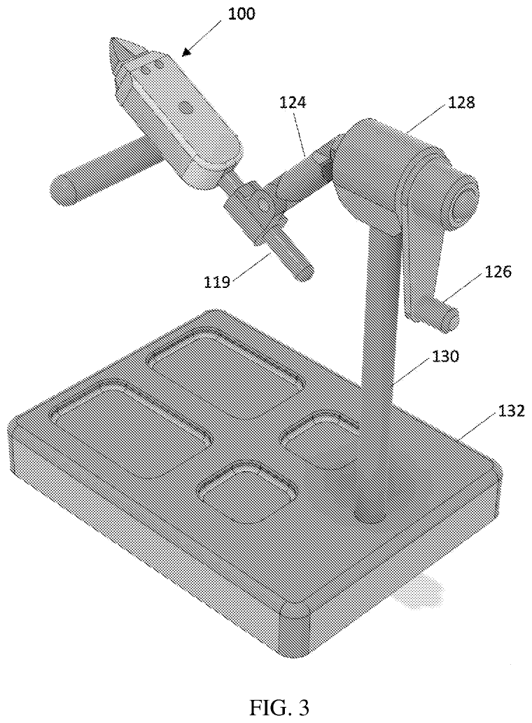

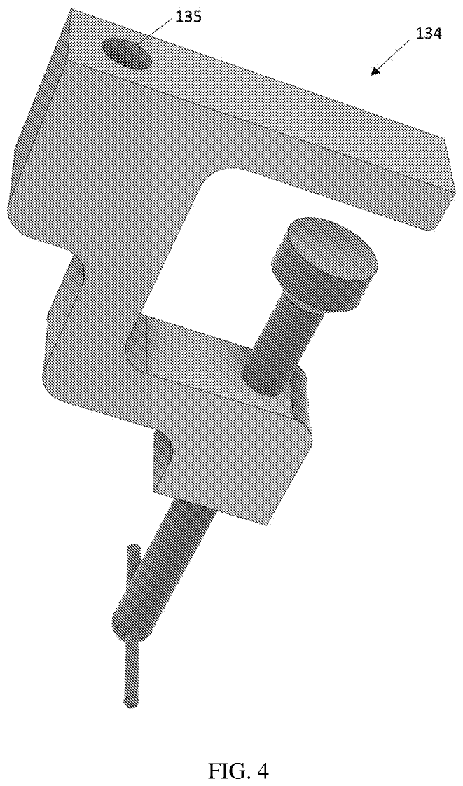

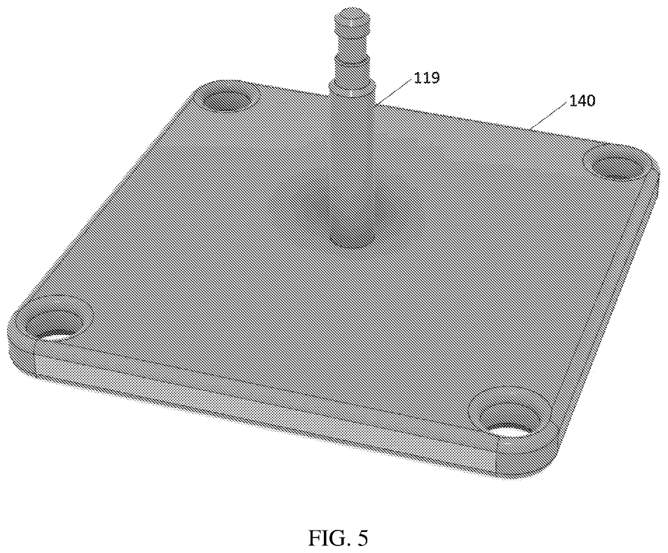

Certain embodiments, as seen in FIG. 3, comprise a vise 100, elongate shaft 119, a rotary vise connection rod 124, a rotary vise handle 136, a rotary rotation cradle 128, a vertical support post 130, and a base 132. In certain embodiments, the vise 100 is removably attached to the first end of the elongate shaft 120 and the second end of the elongate shaft 122 is removably attached to the rotary vise connection rod 124. In certain embodiments, the rotary vise connection rod 124 is interconnected to a rotary vise handle 126, wherein the rotary vise connection rod is partially housed in a rotary rotation cradle 128 that is supported by a vertical support post 130. In some embodiments, the vertical support post 130 is interconnected to a base 132. In some embodiments, the base is capable of self-supporting atop a work surface, as seen in FIG. 3. In some embodiments, the base comprises a clamp 134 for securing the vise to an overhanging edge of a work surface, as seen in FIG. 4, wherein the second end of the elongate shaft 122 is removably attached to a clamp orifice 135. In some embodiments, the base comprises a portable plate attachment 140 wherein the second end of the elongate shaft 122 is removably attached to the portable plate attachment 140, as seen in FIG. 5. In certain embodiments, the second end of the elongate shaft 122 is permanently attached to the portable plate attachment 140. In certain embodiments, the portable plate attachment 140 comprises a plurality of holes to allow for connection of ropes or straps. In certain embodiments, the portable plate attachment 140 comprises one or more of a strap to wear around the body of a person or to an inanimate object (Not shown).

In certain embodiments, one or all of the vise body 102, the orifice on the proximal end of the vise body 118, or the elongate shaft 119 comprises magnetic materials.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A vise for holding objects comprising:
a vise body having a proximal end and a distal end and a central longitudinal axis;
engagement jaws mounted on the distal end of the vise body, the engagement jaws being moveable between an open object-receiving position and a closed object-holding position, the engagement jaws remaining parallel to each other as they are moved between their open and closed positions;
wherein the engagement jaws extend longitudinally along a portion of the central longitudinal axis from the distal end to the proximal end;
the engagement jaws further comprise a first engagement jaw and a second engagement jaw interconnected to the vise body, and the engagement jaws each comprise a parallel interior plane therebetween and a parallel exterior plane opposite the parallel interior plane;
a double lobed cam mounted to the vise body along the central longitudinal axis, positioned perpendicular between the first engagement jaw and the second engagement jaw;
wherein the actuation of the double lobed cam applies a positive pressure to the parallel interior planes of the engagement jaws moving the engagement jaws from the open object-receiving position to the closed object-holding position;
one or more of a spring located between the parallel exterior planes of each engagement jaw and the vise body, the springs are configured to apply an expanding force between the engagement jaws and the vise body in the open object-receiving position; and
an orifice on the proximal end of the vise body capable of receiving a first end of an elongate shaft, wherein the elongate shaft is removably attached to the vise body.

2. The vise of claim 1, wherein a second end of the elongate shaft is removably attached to a rotary vise connection rod that is interconnected to a rotary vise handle.

3. The vise of claim 2, wherein the rotary vise connection rod is partially housed in a rotary rotation cradle, wherein the rotary rotation cradle is supported by a vertical support post.

4. The vise of claim 3, wherein the vertical support post is interconnected to a base.

5. The vise of claim 4, wherein the base comprises a clamp for securing the vise to an overhanging edge of a work surface.

6. The vise of claim 4, wherein the base is capable of self-supporting atop a work surface.

7. The vise of claim 1, wherein the vise body comprises magnetic materials.

8. The vise of claim 1, wherein the orifice on the proximal end of the vise body comprises magnetic materials.

9. The vise of claim 1, wherein the elongate shaft comprises magnetic materials.

10. The vise of claim 1, wherein the double lobed cam is interconnected to a vise handle which actuates rotation of the double lobed cam.

11. The vise of claim 1, wherein the engagement jaws have confronting faces and the confronting faces are provided with at least one complementary transverse arcuate groove for receiving, securing, and holding an object.

12. The vise of claim 1, wherein a second end of the elongate shaft is removably attached to a portable plate attachment.

13. The portable plate attachment of claim 12 further comprising a plurality of holes to allow for the connection of ropes or straps.

14. The portable plate attachment of claim 13, wherein the portable plate attachment comprises one or more of a strap to wear around the body of a person.

15. The portable plate attachment of claim 13, wherein the portable plate attachment comprises one or more of a strap to interconnect the portable plate attachment to an inanimate object.
